(19) United States
(12) Patent Application Publication
(10) Pub. No.: US 2006/0253857 A1
(43) Pub. Date: Nov. 9, 2006

(54) Method for processing a data stream by utilizing multi-processor

(75) Inventors: Po-Cheng Wu, Changhua City (TW); Li-Wei Lu, Jhonge City (TW); Chung-Cheng Chen, Taipei City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Ulead Systems, Inc.

(21) Appl. No.: 11/121,417

(22) Filed: May 4, 2005

(51) Int. Cl. G06F 9/46

(52) U.S. Cl. 718/105

(57) ABSTRACT

The present invention discloses a method for processing a data stream by utilizing plural processors, including the central processing unit and the compression processor of at least one MPEG card. With the similar concept of the distributed system, the present invention could make best use of each processor in the computer and therefore greatly reduce the rendering time. The steps of the method comprises: dividing the data stream into plural segments; checking states of a central processing unit and at least one compressing processor; dispatching the segments to either the central processing unit or the compressing processor according to the statuses, wherein the central processing unit or the compressing processor would process the segments to generate compressed segments; and cascading the compressed segments to generate a compressed data stream.

### FIELD OF THE INVENTION

The present invention is related to a method for processing a data stream by utilizing multi-processor, particularly to a method for compressing a data stream by utilizing the CPU and the compression processor.

### BACKGROUND OF THE INVENTION

With the development of the computer technology, the user is provided more and more applications to capture image, audio or video content. One popular application is that the user may utilize certain editing programs in a computer to process the image or audio/video file after collecting these multimedia data or files. For example, the cutting, merging, transcoding or adding visual/audio effects are typically performed by the user to apply the favorable effect into the image or audio/video file.

As for the processing ability of general personal computer, the processing of multimedia data is certainly time-consuming, especially the compression and de-compression. Therefore, certain users may tend to install one or more compression cards in the extension slots, such as the PCI slot or the USB port, to take the charge of the compression and de-compression tasks. The compression card usually has a processor or single-purpose chip to compress and/or decompress data into or from specific compression format, such as MPEG-1, MPEG-2, MPEG-4, MP3, etc. Since such compression card is dedicated to limited job, that is, compression and decompression, the processing speed thereof is relative higher than that of a computer without such compression card.

However, the types of source data and target data are various, but the supporting source or compression type is limited. That is, for example, the MPEG card may only be able to compress data stream into files in MPEG-2 or MPEG-1 format. In one situation, certain compression cards would support only few types of source, such as the data captured by a digital video camera (DV). If the user desires to edit the MPEG file in various compression types and from several data sources, the rendering job, however, could only be done solely by the CPU of the computer. In this way, the compression card would become useless because of the above-mentioned limitations.

Moreover, the prior methods merely allow the user to choose either one of the processors installed in the computer to process multimedia data stream. The plural processors are not cooperative to implement the heavy-load compression and de-compression jobs. The chosen processor, such as CPU, would be occupied and become extremely busy to execute the assignments, where the others, such as the processors of the MPEG cards, are idle all the time. It is really a kind of inefficiency.

Accordingly, what is desired is a more efficient way to utilize the central processing unit as well as the compression cards for processing a data stream.

### SUMMARY OF THE INVENTION

In view of the aforementioned problems, the present invention therefore provides a method for processing a data stream by utilizing multi-processor installed in a computer. With the method, the user may fully employ every available processor to implement the compression/decompression works. Consequently, the processing time may be reduced by optimizing the usage of the processing ability of each processor.

According to one aspect of the present invention, a method for processing a data stream by utilizing multi-processor is provided. First, the data stream is divided into plural segments, and the states of the central processing unit (CPU) and at least one compressing processor would be checked. After that, the segments are dispatched to either the CPU or the compressing processor according to the checked statuses thereof, and the CPU or the compressing processor would process these dispatched segments to generate compressed segments. Finally, the compressed segments would be cascaded to generate a compressed data stream.

According to another aspect of the present invention, a storage medium having executable instructions is provided. The storage medium includes plural functional modules to process a data stream by utilizing multi-processor through performing the following steps: dividing the data stream into plural segments; checking states of a central processing unit and at least one compressing processor; dispatching the segments to either the central processing unit or the compressing processor according to the statuses, wherein the central processing unit or the compressing processor would process the segments to generate compressed segments; and cascading the compressed segments to generate a compressed data stream.

### BRIEF DESCRIPTION OF THE DRAWINGS

FIG. 1 shows editing process of the data stream.

FIG. 2 is a block diagram showing the hardware architecture of the computer.

FIG. 3 is a flowchart showing the processing steps.

FIG. 4 is a flow chart showing the dispatching steps.

FIG. 5 is a block diagram showing the storage medium according to the present invention.

### DETAILED DESCRIPTION OF THE PREFERRED EMBODIMENT

The present invention is described with the preferred embodiments and accompanying drawings. It should be appreciated that all the embodiments are merely used for illustration. Although the present invention has been described in terms of a preferred embodiment, the invention is not limited to this embodiment. The scope of the invention is defined by the claims. Modifications within the spirit of the invention will be apparent to those skilled in the art.

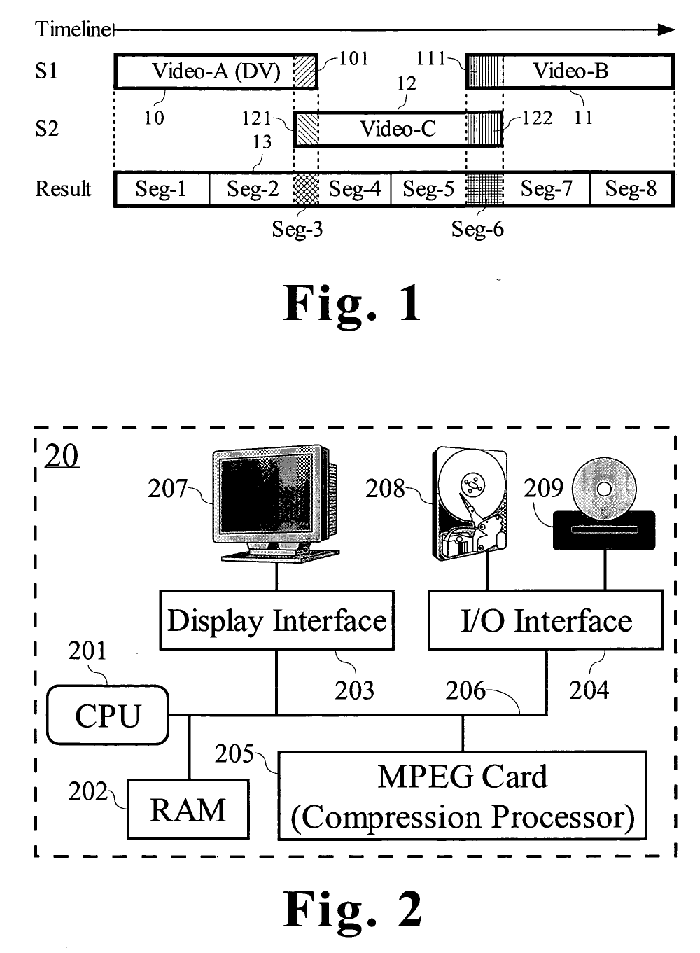

Referring to FIG. 1, one embodiment of the source of the data stream is illustrated. The Result strip 13 in the drawing represents the data stream in the embodiment. The user may apply certain editing application to generate such data stream and compress it into a file in specific format, such as MPEG-1 or the like. According to the embodiment illustrated in FIG. 1, the data stream is formed by combining three video files, which are video-A 10, video-B 11 and video-C 12, and the transition effects are added in the overlapped sections thereof. It should be noted that the types of the files are not limited to video data, but also include audio, image, text and other possible multimedia data. The video files 10-12 hereinafter are merely illustrated for exemplification.

Besides, the sources and formats of the video files 10-12 may be various. In one embodiment of the present invention, the video-A 10 is captured from a digital video camera (DV), the video-B 11 comes from a digital video disc (DVD), and the video-C 12 is a MPEG-1 file stored in the hard disc of the computer. They are arranged in sequence and combined into a MPEG-1 file with transition effects. As we can see, video-A 10 and video-C 12 are partially overlapped, and the overlapped sections 101 and 121 (jointly Seg-3) are associated with certain transition effect. Similarly, video-C 12 and video-B 11 are also partially overlapped, and the overlapped sections 111 and 122 jointly Seg-6) are associated with certain transition effect. After being edited, the result would be further processed to generate a compressed file.

Referring to FIG. 2, the simplified computer architecture is illustrated. The computer 20 is comprised of a CPU 201, RAM 202, display interface 203 and I/O interface 204. In the preferred embodiment of the present invention, the computer further comprises a MPEG card with a compression processor, which has the ability to compress and decompress data in MPEG-2 format. It should be noted that the MPEG card could be replaced by any other possible and equivalent compression card, and therefore, the supported compression format should be associated with the corresponding MPEG format. In addition, the number of the compression card in the computer 20 may be more than one. As mentioned, the type of supported compression format depends on the ability of the compression card. It means that the compression card may only support one of the specific compression formats, it includes but not limited to MPEG-1, MPEG-2 and MPEG-4, etc. The user may choose and install one or more compression card on one's demand. In the preferred embodiment, the computer is installed a MPEG card which supports MPEG-1 format.

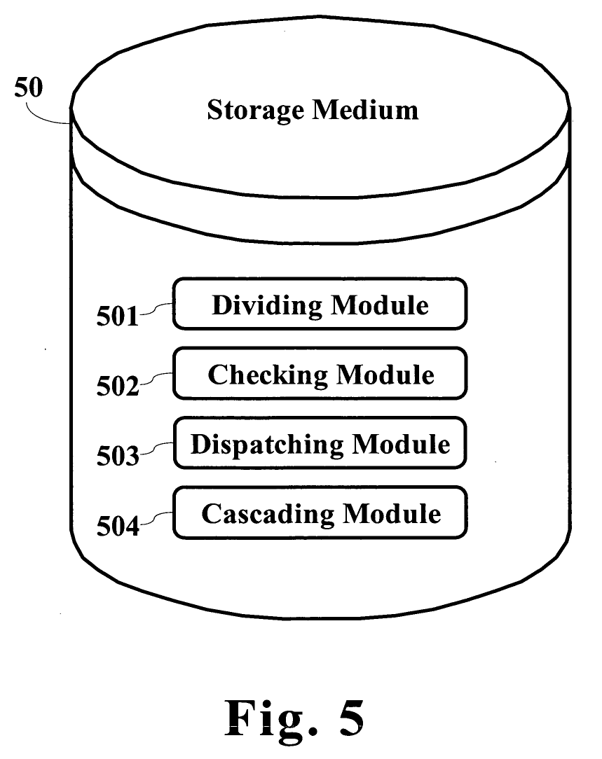

These elements mentioned above are connected by the system bus 206 as known in the art. Certainly, the computer 20 may still include other elements or devices to perform the certain function. However, they are not the major aspect of the invention, therefore, the detailed description is omitted. The display interface 203 may couple to a display 207, and the I/O interface may couple to the hard disc 208 or the CD/DVD drive 209. Preferably, the drive 209 could also read the data stored in the storage medium 50 shown in FIG. 5. The details of the storage medium 50 would be described latter. According to the preferred embodiment of the present invention, the video-B 11 is obtained from the DVD in the drive 209, and the video-C 12 is stored in the hard disc 208. Any alternative arrangement is possible.

After the data stream is edited, the data stream is required to be further processed, and the following processed is so-called “rendering.” The present invention introduces the concept of distributed system into the rendering process. However, the distributed system applies plural computers working concurrently to finish certain computations, but the present invention could use merely one computer to achieve the remarkable effect and result, and therefore enhance the efficiency.

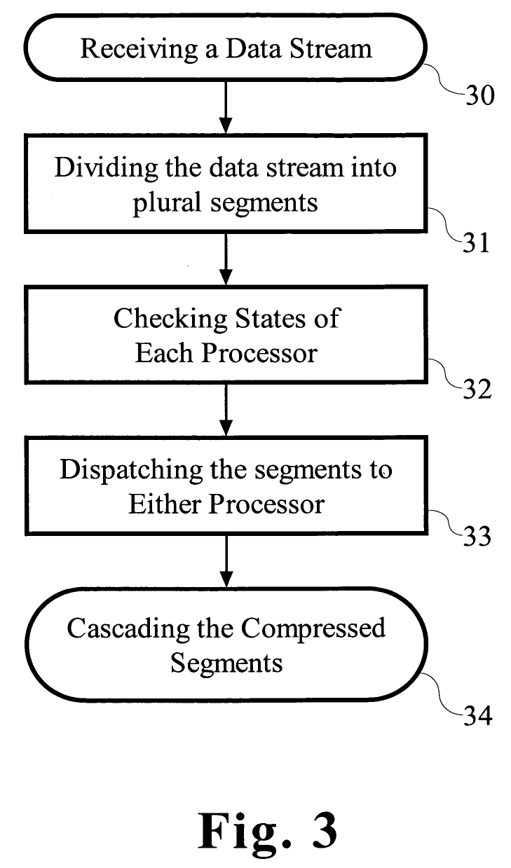

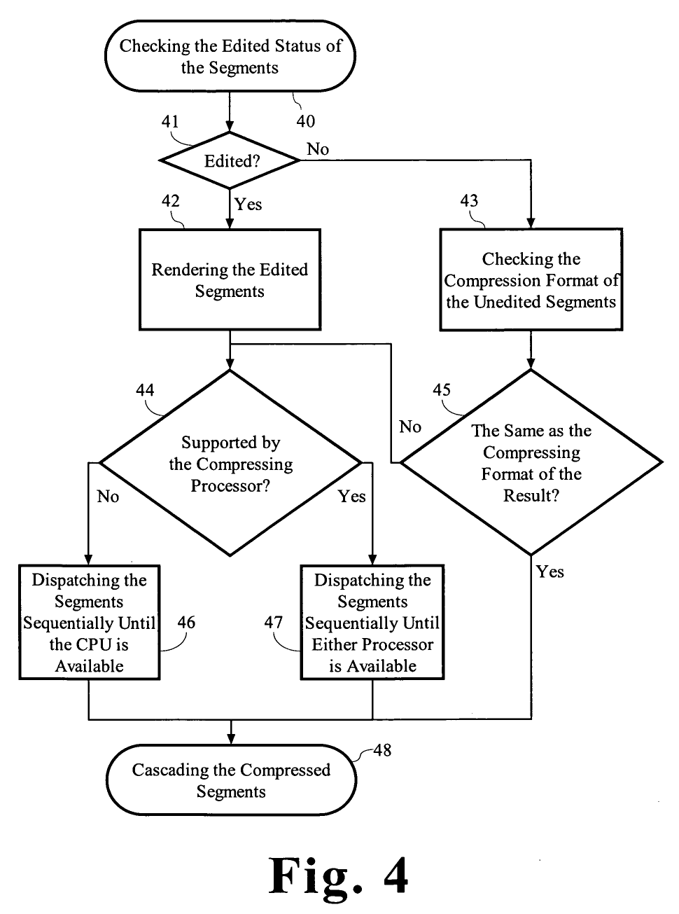

Referring to FIG. 3, it illustrates the flowchart for the rendering process according to the present invention. The data stream is received in step 30. After that, the data stream is divided into plural segments in step 31. The dividing would depend on the data types and edited statuses of the data stream. Referring back to FIG. 1, the Result strip 13 representing the data stream is divided into eight segments and indicated by the Seg-1 to Seg-8. The segments 1-8 preferably have the same time interval, but may be adjusted according to the data types and edited statuses. For example, as shown in FIG. 1, the portions coming from the different sources, usually in different data types, are preferably separated. Moreover, the portions with different edited statuses are also preferably separated. In the embodiment shown in FIG. 1, the edited statuses of Seg-3 and Seg-6 are contrary to those of other segments because of the overlapped situation and the adding of transition effects. These segments, namely Seg-3 and Seg-6, usually require more processing time.

Next, the states of each processor in the computer 20 would be checked in step 32. The processors include CPU 201 and the compression processor in the MPEG card 205. The information of the states may include the availabilities and supporting compression formats of the processors. Then, the segments would be dispatched to certain processor which is available and supports the compression formats of the source data as well as the target data, as shown in step 33. The detail procedures of dispatching would be described in the following description. Finally, the processed and compressed segments would be cascaded to generate a desired compressed file, namely a file in MPEG-1 format for instance. The dividing of data stream, the checking of the states and the dispatching of segments illustrated above are preferably performed by the CPU 201.

Referring to FIG. 4, one preferred embodiment of the detail dispatching procedures is presented. In the procedure, the CPU 201 would check whether the segments are edited or not, as shown in steps 40 and 41 for checking the edited statuses of the segments. For example, Seg-3 and Seg-6 are edited and other segments are unedited.

If the determination is that the segments are not edited, then the compression format of these unedited segments would be checked in step 43. Subsequently, the next step 45 is performed to identify whether or not the compression formats of the segments are substantially identical to those of the result, namely MPEG-1 in this embodiment, and with the same attributes, such as the frame dimension, the frame rate, the bit rate, the display aspect ratio, and the frame type (progressive or interlaced). If the determination is positive, the segments would bypass the processing (including rendering) and compressing steps, and be directly cascaded when other segments are compressed. For example, since Seg-4 and Seg-5 are unedited and have the same compression format of the result, these two segments may be referred as constant segments and bypass the time-consuming rendering and compression procedure. If the compression formats of segments are not identical to those of the result, the segments are required to be transcoded. For example, the Seg-7 and Seg-8 are DVD video data and therefore they are required to be decompressed and then compressed into MPEG-1. In another embodiment, the Seg-7 and Seg-8 may be MPEG-1 video data and the desired compression type of the result may be MPEG-2. It should be noted that the present invention could compass all kinds of compression types, and the above-mentioned examples are merely cited for illustration instead of limitation. In this situation, the procedure would proceed to step 44, which would be discussed in subsequent description.

Turning back to step 41, if the determination of step 41 is that the segments are edited, namely Seg-3 and Seg-6, the edited segments would be rendered in step 42. Generally, the rendering procedure may be implemented solely by the CPU 201. However, if other processor has the rendering capability, the rendering job may be dispatched to such processor as being available. In this situation, the concept of multi-processor could also be applied in the rendering procedure.

Because the rendering of the edited segments requires the decompression procedure, the dispatched processor should support the original compression format of the segments and the procedure will be determined in step 44. In the step 44, the source of the segments would also be taken into consideration, since the compression card may merely support certain sources, such as data from a DV or a hard disc.

In the determination, if the compression format and the source of the segments are both supported by each processor, the segments could be dispatched sequentially to any available processor, including the CPU 201 and the compression processor 205, as shown in step 47. Otherwise, the segments would be dispatched sequentially until the CPU 201 is available, since these segments could be processed only by the CPU 201, as shown in step 46.

Finally, the processed and compressed segments would be cascaded in step 48 to generate a file in desired compression format, namely MPEG-1 in this embodiment.

Referring to FIG. 5, the storage medium 50 according to one embodiment of the present invention is illustrated. The storage medium 50 may be a compact disc (CD), a digital versatile/video disc (DVD), a floppy disc, a hard disc or memory. It should be noted that the present invention is not limited to these exemplary types of storage medium. The storage medium 50 has executable instructions for performing the steps described above by utilizing plural processors. The instructions are collected as several modules, which are dividing module 501, checking module 502, dispatching module 503 and cascading module 504. Generally, the types of modules include the program, software or even a list of instructions. The storage medium 50 could be applied by a computer or other computing devices to perform the functions and operations mentioned above. In order to avoid the redundancy, the similar description is omitted here. The storage medium having executable instructions for processing a data stream by utilizing multi-processor through performing the following steps comprises: dividing the data stream into plural segments; checking states of a central processing unit and at least one compressing processor; dispatching the segments to either the central processing unit or the compressing processor according to the statuses, wherein the central processing unit or the compressing processor processes the segments to generate compressed segments; and cascading the compressed segments to generate a compressed data stream.

As is understood by a person skilled in the art, the foregoing preferred embodiments of the present invention are illustrated of the present invention rather than limiting of the present invention. It is intended to cover various modifications and similar arrangements included within the spirit and scope of the appended claims, and the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A method for processing a data stream by utilizing multi-processor, which comprises:
dividing said data stream into plural segments;
checking states of a central processing unit and at least one compressing processor;
dispatching said segments to either said central processing unit or said compressing processor according to said statuses, wherein said central processing unit or said compressing processor processes said segments to generate compressed segments; and
cascading said compressed segments to generate a compressed data stream.

2. The method as set forth in claim 1, wherein said data stream includes multimedia data having compressed data or uncompressed data.

3. The method as set forth in claim 1, wherein said data stream is divided according to data types and edited status thereof.

4. The method as set forth in claim 3, wherein said data types includes compression formats or source types of said data stream.

5. The method as set forth in claim 3, wherein said edited status indicates which portions of said data stream are edited.

6. The method as set forth in claim 1, wherein said states include availabilities and supporting compression formats of said central processing unit and said compressing processor.

7. The method as set forth in claim 1, wherein said compressing processor includes the processor of a compression card, and said compression card is installed in a computer having said central processing unit.

8. The method as set forth in claim 1, wherein said segments are dispatched sequentially until said states indicating that either of said central processing unit and said compressing processor is available.

9. The method as set forth in claim 1, wherein said segments include at least one constant segment which is cascaded without being compressed by said central processing unit or said compressing processor.

10. The method as set forth in claim 9, wherein said constant segment is not edited and the compression format of said constant segment is the same as that of said compressed data stream.

11. The method as set forth in claim 1, which further comprises:
rendering said segments which have at least one edited portion before dispatching.

12. A storage medium having executable instructions for processing a data stream by utilizing multi-processor through performing the following steps, which comprises:
dividing said data stream into plural segments;
checking states of a central processing unit and at least one compressing processor;
dispatching said segments to either said central processing unit or said compressing processor according to said statuses, wherein said central processing unit or said compressing processor processes said segments to generate compressed segments; and
cascading said compressed segments to generate a compressed data stream.

13. The storage medium as set forth in claim 12, wherein said data stream includes multimedia data having compressed data or uncompressed data.

14. The storage medium as set forth in claim 12, wherein said data stream are divided according to data types and edited status thereof.

15. The storage medium as set forth in claim 14, wherein said data types includes compression formats or source types of said data stream.

16. The storage medium as set forth in claim 14, wherein said edited status indicates which portions of said data stream are edited.

17. The storage medium as set forth in claim 12, wherein said states include availabilities and supporting compression formats of said central processing unit and said compressing processor.

18. The storage medium as set forth in claim 12, wherein said compressing processor includes the processor of a compression card, and said compression card is installed in a computer having said central processing unit.

19. The storage medium as set forth in claim 12, wherein said segments are dispatched sequentially until said states indicating that either of said central processing unit and said compressing processor is available.

20. The storage medium as set forth in claim 12, wherein said segments include at least one constant segment which is cascaded without being compressed by said central processing unit or said compressing processor.

21. The storage medium as set forth in claim 20, wherein said constant segment is not edited and the compression format of said constant segment is the same as that of said compressed data stream.

22. The storage medium as set forth in claim 12, wherein said steps further comprises:
rendering said segments which have at least one edited portion before dispatching.
